(19) United States
(12) Patent Application Publication
(10) Pub. No.: US 2019/0271608 A1
(43) Pub. Date: Sep. 5, 2019

(54) METHOD TO ESTIMATE COMPRESSOR INLET PRESSURE FOR A TURBOCHARGER

(71) Applicant: GM Global Technology Operations LLC, Detroit, MI (US)

(72) Inventors: Yue-Yun Wang, Troy, MI (US); Yiran Hu, Shelby Township, MI (US)

(21) Appl. No.: 15/909,093

(22) Filed: Mar. 1, 2018

(51) Int. Cl. G01L 23/24; F02B 37/18; F02B 37/24; F02M 35/10; F02B 77/08; G01L 11/00

(52) U.S. Cl. CPC G01L 23/24; F02B 37/183; F02B 37/24; F02M 35/10386; G01M 15/14; F02B 77/086; G01L 11/002; F02M 35/10157; F02M 35/1038

(57) ABSTRACT

A method of estimating a compressor inlet pressure for a turbocharger includes: measuring an ambient temperature of air flowing into the compressor; measuring a flow rate of the air into the compressor; measuring a boost pressure of the air from the compressor to an engine; determining a speed of a turbine of the turbocharger; defining a pressure ratio as the ratio of the boost pressure to the compressor inlet pressure; defining a function as the function of the compressor flow rate, the ambient temperature, the compressor inlet pressure and the turbine speed; and equating the pressure ratio and the function and recursively solving for the compressor inlet pressure.

### INTRODUCTION

The present disclosure relates to a method of estimating ambient pressure. More specifically, the present disclosure relates to a method of estimating inlet pressure of a compressor for a turbocharger.

Internal combustion engines are supplied with a mixture of air and fuel for combustion within the engine that generates mechanical power. To maximize the power generated by this combustion process, the engine can be equipped with a turbocharger.

A turbocharger includes a turbine that utilizes exhaust from the engine to drive a compressor to compress air flowing into the engine, which forces more air into a combustion chamber of the engine than a naturally aspirated engine. To monitor the performance of the turbocharger, a pressure sensor is employed to measure the ambient pressure of the airflow into the compressor. Such a sensor requires full time on-board diagnostics. Existing diagnostics, however, are complicated and are also very difficult to calibrate. Accordingly, two pressure sensors have been utilized so that the sensors can diagnose each other.

Thus, while current ambient pressure sensors for turbochargers achieve their intended purpose, there is a need for a new and improved method for determining the ambient pressure of the airflow into a compressor of a turbocharger.

### SUMMARY

According to several aspects, a method of estimating a compressor inlet pressure for a turbocharger includes: measuring an ambient temperature of air flowing into the compressor; measuring a flow rate of the air into the compressor; measuring a boost pressure of the air from the compressor to an engine; determining a speed of a turbine of the turbocharger; defining a pressure ratio as the ratio of the boost pressure to the compressor inlet pressure; defining a function as the function of the compressor flow rate, the ambient temperature, the compressor inlet pressure and the turbine speed; and equating the pressure ratio and the function and recursively solving for the compressor inlet pressure.

In an additional aspect of the present disclosure, the method further includes measuring an exhaust flow rate of exhaust gas from the engine, measuring an exhaust temperature of the exhaust gas, measuring a wastegate position that controls the flow rate of the exhaust gas that bypasses the turbine, and determining the turbine speed as a function of the exhaust flow rate, the exhaust temperature, the compressor inlet pressure, and the wastegate position.

In another aspect of the present disclosure, recursively solving is based on a linear parameter varying (LPV) dynamic model.

In another aspect of the present disclosure, the LPV dynamic model employs a Kalman filter, the estimated compressor inlet pressure being an output of the Kalman filter.

In another aspect of the present disclosure, the method further includes measuring an ambient pressure with a sensor, and determining a residual as the difference between the estimated compressor inlet pressure and the ambient pressure, the residual providing fault detection isolation.

In another aspect of the present disclosure, the turbine is a variable geometry turbine.

In another aspect of the present disclosure, when the estimated compressor inlet pressure has abrupt changes within a specified time and is greater than the ambient pressure, the fault detection isolation indicates that the variable geometry turbine is stuck open.

In another aspect of the present disclosure, when the estimated compressor inlet pressure has abrupt changes within a specified time and is less than the ambient pressure, the fault detection isolation indicates that the variable geometry turbine is stuck closed.

In another aspect of the present disclosure, when the estimated compressor inlet pressure is less than the ambient pressure, the fault detection isolation indicates that there is a fault in a sensor measuring the boost pressure.

According to several aspects, a method of estimating a compressor inlet pressure for a turbocharger includes: measuring an ambient temperature of air flowing into the compressor; measuring a flow rate of the air into the compressor; measuring a boost pressure of the air from the compressor to an engine; determining a speed of a turbine of the turbocharger; defining a pressure ratio as the ratio of the boost pressure to the compressor inlet pressure; defining a function as the function of the compressor flow rate, the ambient temperature, the compressor inlet pressure and the turbine speed; and equating the pressure ratio and the function and recursively solving for the compressor inlet pressure, wherein recursively solving is based on a linear parameter varying (LPV) dynamic model that employs a Kalman filter, the estimated compressor inlet pressure being an output of the Kalman filter.

In additional aspect of the present disclosure, the method further includes measuring an exhaust flow rate of exhaust gas from the engine, measuring an exhaust temperature of the exhaust gas, measuring a wastegate position that controls the flow rate of the exhaust gas that bypasses the turbine, and determining the turbine speed as a function of the exhaust flow rate, the exhaust temperature, the compressor inlet pressure, and the wastegate position.

In another aspect of the present disclosure, the method further includes measuring an ambient pressure with a sensor, and determining a residual as the difference between the estimated compressor inlet pressure and the ambient pressure, the residual providing fault detection for the ambient pressure sensor or fault isolation to other boosting system failure modes.

In another aspect of the present disclosure, the turbine is a variable geometry turbine.

In another aspect of the present disclosure, when the estimated compressor inlet pressure has abrupt changes within a specified time and is greater than the ambient pressure, the fault detection isolation indicates that the variable geometry turbine is stuck open.

In another aspect of the present disclosure, when the estimated compressor inlet pressure has abrupt changes within a specified time and is less than the ambient pressure, the fault detection isolation indicates that the variable geometry turbine is stuck closed.

In another aspect of the present disclosure, when the estimated compressor inlet pressure is less than the ambient pressure, the fault detection isolation indicates that there is a fault in a sensor measuring the boost pressure.

According to several aspects, a method of estimating a compressor inlet pressure for a turbocharger includes: measuring an ambient temperature of air flowing into the compressor; measuring a flow rate of the air into the compressor; measuring a boost pressure of the air from the compressor to an engine; measuring an exhaust flow rate of exhaust gas from the engine to a turbine; measuring an exhaust temperature of the exhaust gas; measuring a wastegate position that controls the flow rate of the exhaust gas that bypasses the turbine; determining a speed of the turbine as a function the exhaust flow rate, the exhaust temperature, the compressor inlet pressure, and the wastegate position; defining a pressure ratio as the ratio of the boost pressure to the compressor inlet pressure; defining a function as the function of the compressor flow rate, the ambient temperature, the compressor inlet pressure and the exhaust flow, the exhaust temperature, the wastegate position; and equating the pressure ratio and the function and recursively solving for the compressor inlet pressure.

In an additional aspect of the present disclosure, recursively solving is based on a linear parameter varying (LPV) dynamic model.

In another aspect of the present disclosure, the LPV dynamic model employs a Kalman filter, the estimated compressor inlet pressure being an output of the Kalman filter.

In another aspect of the present disclosure, the method further includes measuring an ambient pressure with a sensor, and determining a residual as the difference between the estimated compressor inlet pressure and the ambient pressure, the residual providing fault detection isolation.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic of a turbocharger system for a motor vehicle in accordance with the principles of the present disclosure;

FIG. 2 is a graph illustrating a comparison of an estimated boost pressure to inlet compressor pressure ratio to an actual boost pressure to inlet compressor pressure ratio for the turbocharger system shown in FIG. 1;

FIG. 3 is a process diagram to estimate a compressor inlet pressure for the turbocharger system shown in FIG. 1;

FIG. 4A is a graph of a calculated boost pressure from the process shown in FIG. 3;

FIG. 4B is a graph of an estimated compressor inlet pressure from the process shown in FIG. 3;

FIG. 5 is a process diagram to calculate a residual with the process shown in FIG. 3;

FIG. 6 is a graph showing a comparison between an actual ambient pressure measurement and an estimated compressor inlet pressure to determine a fault detection isolation of a pressure sensor; and

FIG. 7 is a graph showing fault detection isolation of a variable geometry turbine and a boost pressure sensor.

### DETAILED DESCRIPTION

The following description is merely exemplary in nature and is not intended to limit the present disclosure, application, or uses.

Referring to FIG. 1, there is shown a turbocharger system 10 in accordance with the principles of the present disclosure. The turbocharger system 10 includes a turbocharger 12 with a turbine 14 connected to a compressor 16 with a drive link or shaft 18. The turbocharger system 10 further includes one or more sensors 20 that measures the flow rate of air, W_{c}, into the compressor 16, the ambient temperature Tₐ and the ambient pressure pₐ of the air flowing into the compressor 16, an air cooler 22, a pressure sensor 24 that measures the boost pressure pᵢ of the air flowing into an engine 28, and a temperature sensor 26 that measures the boost temperature Tᵢ of the air flowing into the engine 28.

The temperature Tₑₓ and pressure pₑₓ of the exhaust gas from the engine 28 is measured by a temperature sensor 30 and a pressure sensor 32, respectively. The exhaust gas flows to the turbine 14 with a flow rate Wₑₓ is estimated from the measured flow rate of air and injected fuel flow, and the outlet pressure pₜₒ of the exhaust gas from the turbine 14 is measured by a sensor 42. A waste gate 40 provides a path for a desired amount of the exhaust gas to bypass the turbine 14. The path line for air flowing between the compressor 16 and the engine 28 and the path line exhaust gas flowing from the engine 28 to the compressor 16 are connected by a path line with an exhaust gas recirculation (EGR) cooler 36 and an EGR valve 34 that directs some of the exhaust gas from the exhaust path line to the air path line. This line also includes a path line 38 that allows some of the exhaust gas to bypass the EGR cooler 36.

In a typical operation of the turbocharger system 10, exhaust gas flows into the turbine 14. As the turbine 14 spins with a speed of Nₜ, the turbine 14 drives the compressor 16 with the drive link or shaft 18. As the compressor 16 spins, air is drawn into the compressor 16 with a flow rate W_{c}.

The dynamics of the air flow and exhaust flow through the turbocharger system 10 can be described by the following set of expressions:

$$\begin{matrix}{p}_{rc} = \frac{{p}_{i}}{{p}_{a}} = f ( \frac{{W}_{C} \sqrt{{T}_{a}}}{{p}_{a}} , {N}_{t} ) \\ \approx f ( \frac{{W}_{C} \sqrt{{T}_{a}}}{{p}_{a}} , g ( \frac{{W}_{ex} \sqrt{{T}_{ex}}}{{p}_{a}} , WG ) ) \\ = H ( \frac{{W}_{C} \sqrt{{T}_{a}}}{{p}_{a}} , \frac{{W}_{ex} \sqrt{{T}_{ex}}}{{p}_{a}} , WG ) \\ = H ( {x}_{1} ( {p}_{a} ) , {x}_{2} ( {p}_{a} ) , {x}_{3} )\end{matrix} \qquad Eq . 1$$

where p_{rc} is the pressure ratio of pᵢ and pₐ, ƒ is a function of W_{c}, Tₐ, pₐ, and Nₜ, and where Nₜ is written as a function g of Wₑₓ, Tₑₓ, pₐ, and WG, which is the position of the wastegate 40. Hence, the pressure ratio p_{rc} can be expressed as a function H, which is a function of x₁(pₐ), x₂(pₐ), x₃ as shown above.

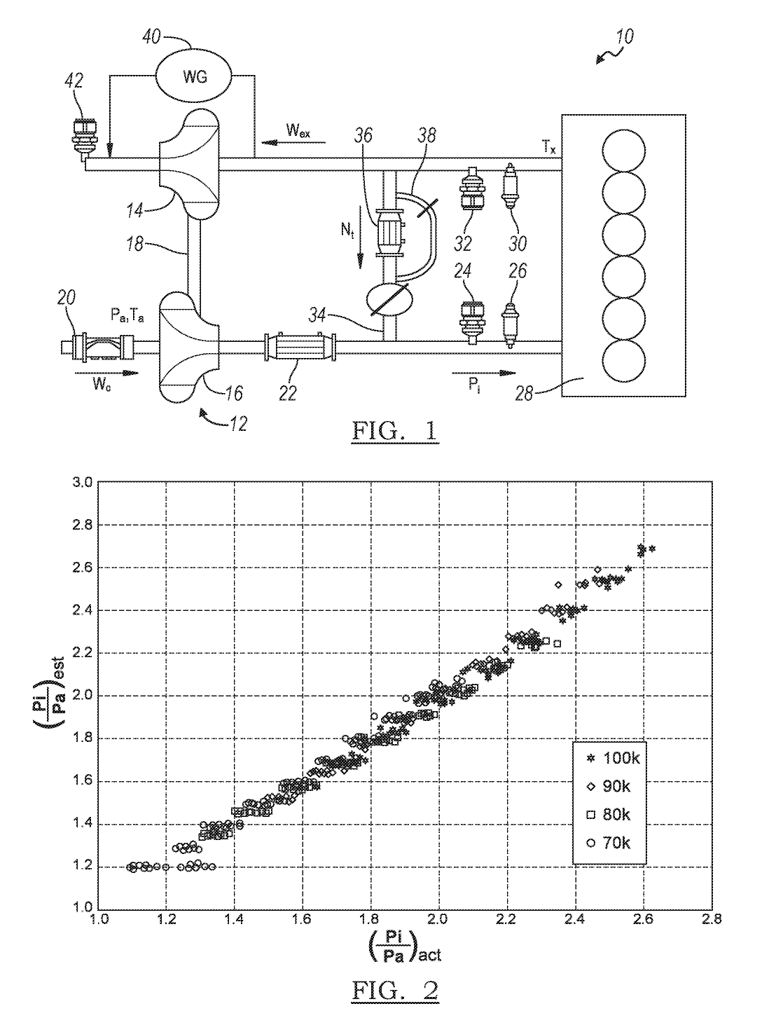

Referring to FIG. 2, there is shown a comparison of the actual pressure ratio (pᵢ/pₐ)_{act} measured with the sensors 20 and 24 to the estimated pressure ratio (pᵢ/pₐ)ₑₛₜ obtained with the expressions shown in Eq. 1 described above for various ambient pressure at 100 kPa, 90 kPa; 80 kPa; and 70 kPa.

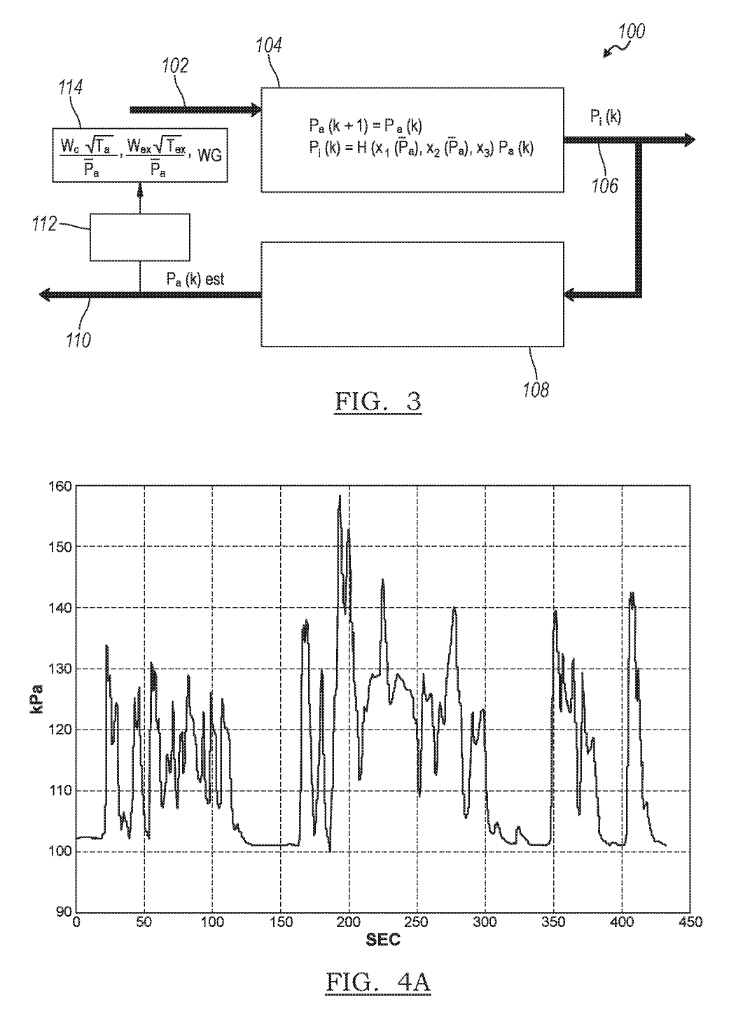

Referring to FIG. 3, there is shown a process 100 that implements the expressions Eq. 1 to estimate a compressor inlet pressure pₐ(k)ₑₛₜ for a step k in a recursive analysis. Specifically, the processes 100 employs a linear parameter varying (LPV) model that relates engine air and exhaust gas flow with the ambient pressure. The estimated ambient pressure or compressor inlet pressure can then be utilized to diagnose the operation of the sensor 20 that measures the actual ambient pressure. As such, the H function (114)

$$H ( \frac{{W}_{C} \sqrt{{T}_{a}}}{{p}_{a}} , \frac{{W}_{ex} \sqrt{{T}_{ex}}}{{p}_{a}} , WG ) \qquad Eq . 2$$

is provided as inputs 102 to the process 100. Note that in Eq. 2, the barred values of pₐ are moving averages of the estimated ambient pressure. That is the output 110 of the process 100 generates moving averages 112 that are incorporated into the H function 114.

The inputs 102 are implemented into the process 100 as the recursive expressions

pₐ(k+1)=pₐ(k)

pᵢ(k)=H(x₁(p̅ₐ)),x₂(p̅ₐ),x₃)pₐ(k) Eq. 3

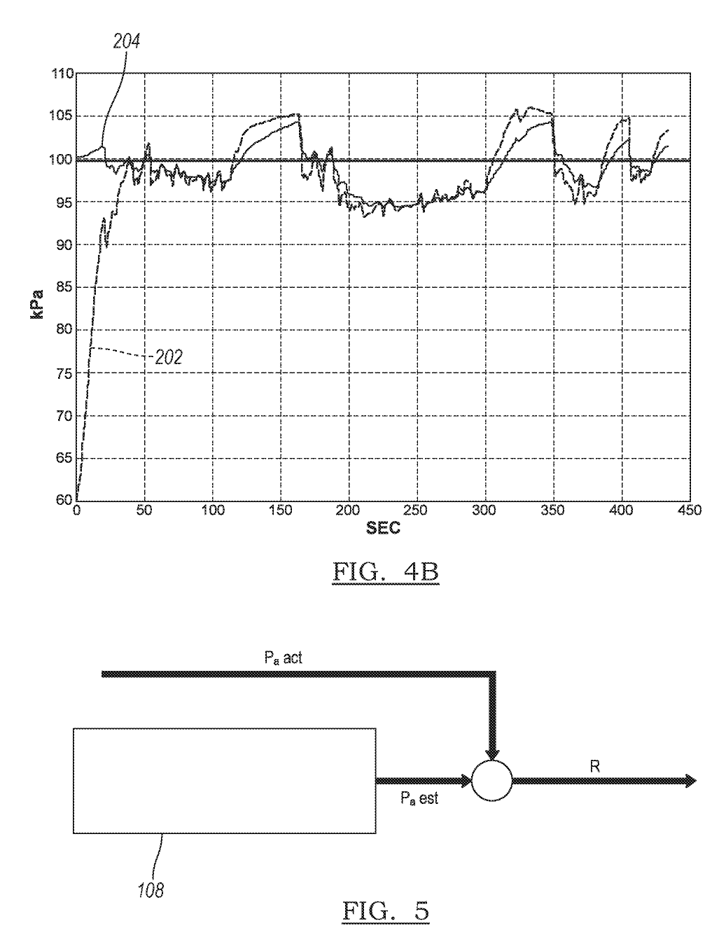

in a step 104, where again k is the kth step of the recursive calculation. The step 104 calculates a boost pressure pᵢ(k). Example calculations of the boost pressure pᵢ in kPa are shown in FIG. 4A. The process 100 proceeds to a step 108, which is a Kalman filter. The Kalman filter 108 then provides an estimated ambient pressure or compressor inlet pressure pₐ(k)ₑₛₜ as an output 110. Example calculations of the output 110 are shown in FIG. 4B. More specifically, FIG. 4B shows a comparison of the measured ambient pressure 202 to the estimated ambient pressure 204.

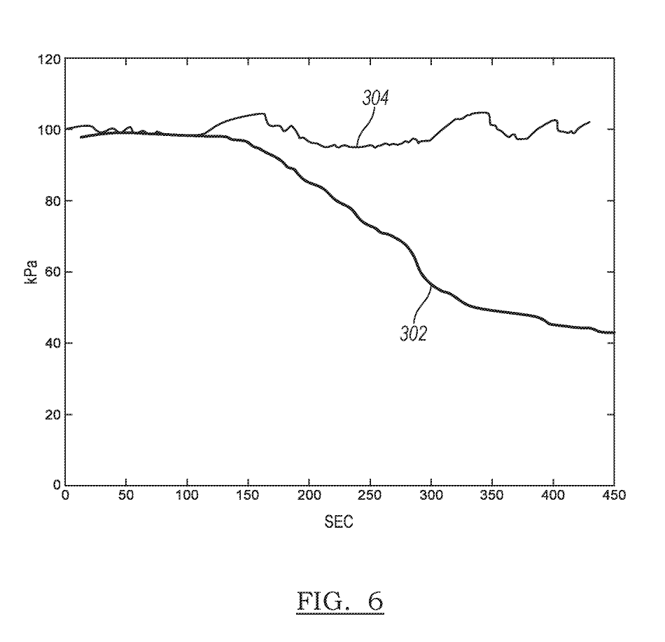

Turning now to FIG. 5, there is shown that the output pₐ(k)ₑₛₜ from the Kalman filter 108 and the measured ambient pressure p_{aact} can be utilized to determine a residual R, which in turn can be employed for system diagnostics to isolate a fault detection. For example, as shown in FIG. 6, if the measured ambient pressure 302 diverges from the estimated ambient pressure 304 within a specified vehicle travel distance where the ambient pressure is not expected change much as indicated by its estimated value. then residual or difference between the estimated ambient pressure 304 and the measured ambient pressure 302 may indicated that the sensor 20 that measures the ambient pressure may have a fault or is defective.

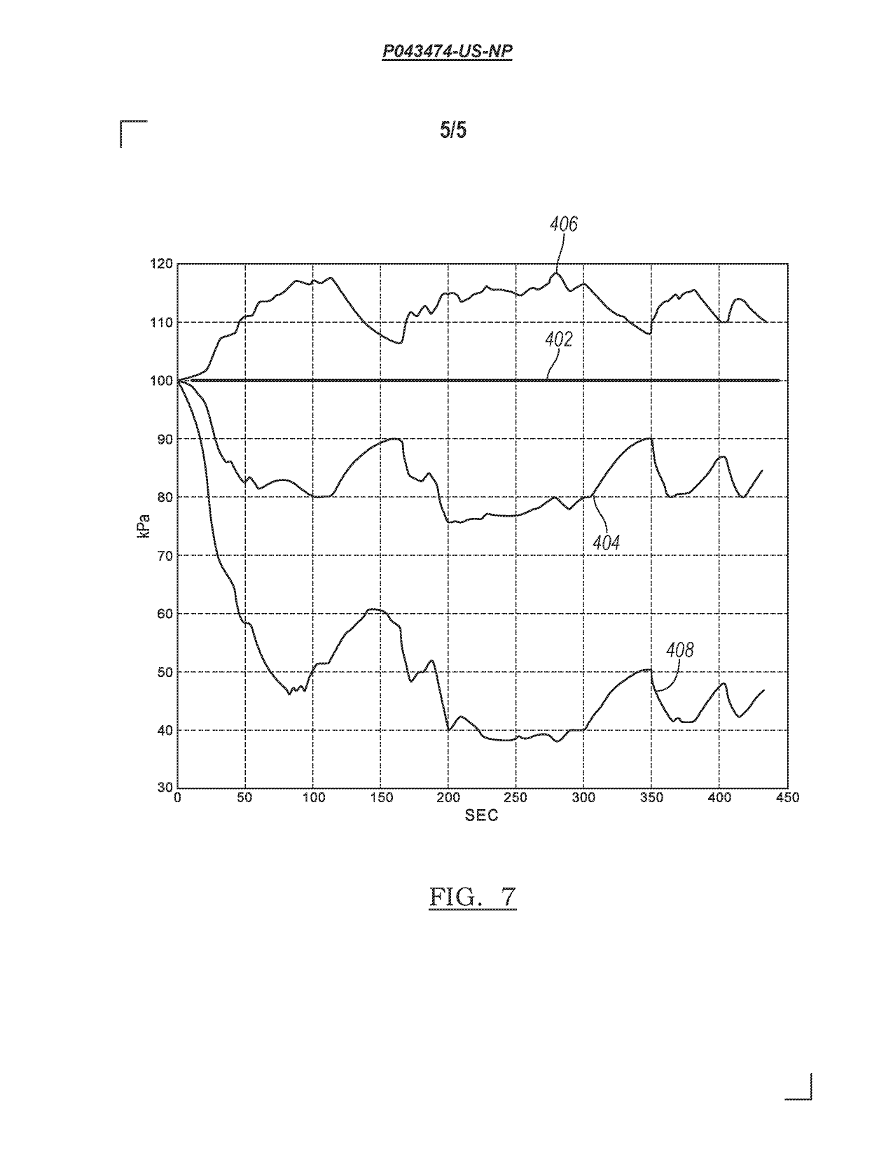

As shown in FIG. 7, the system diagnostics can be utilized for other purposes as well. For example, the non-varying measured ambient pressure 402 indicates that the sensor 20 is working properly within a limited vehicle travel distance. The estimated ambient pressure 404, however, shows a larger change in value, which may indicate that a variable geometry turbine (VGT) is stuck open, whereas the estimated ambient pressure 406 may indicate that the VGT is stuck closed. Further, the estimated ambient pressure 408 may indicate that the sensor 24 is not operating properly.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of estimating a compressor inlet pressure for a turbocharger, the method comprising:
measuring an ambient temperature of air flowing into the compressor;
measuring a flow rate of the air into the compressor;
measuring a boost pressure of the air from the compressor to an engine;
determining a speed of a turbine of the turbocharger;
defining a pressure ratio as the ratio of the boost pressure to the compressor inlet pressure;
defining a function as the function of the compressor flow rate, the ambient temperature, the compressor inlet pressure and the turbine speed; and
equating the pressure ratio and the function and recursively solving for the compressor inlet pressure.

2. The method of claim 1 further comprising measuring an exhaust flow rate of exhaust gas from the engine, measuring an exhaust temperature of the exhaust gas, measuring a wastegate position that controls a flow rate of the exhaust gas that bypasses the turbine, and determining the turbine speed as a function of the exhaust flow rate, the exhaust temperature, the compressor inlet pressure, and the wastegate position.

3. The method of claim 1 wherein recursively solving is based on a linear parameter varying (LPV) dynamic model.

4. The method of claim 3 wherein the LPV dynamic model employs a Kalman filter, the estimated compressor inlet pressure being an output of the Kalman filter.

5. The method of claim 1 further comprising measuring an ambient pressure with a sensor, and determining a residual as the difference between the estimated compressor inlet pressure and the ambient pressure, the residual providing fault detection isolation.

6. The method of claim 5 wherein the turbine is a variable geometry turbine.

7. The method of claim 6 wherein when the estimated compressor inlet pressure has abrupt changes within a specified time and is greater than the ambient pressure, the fault detection isolation indicates that the variable geometry turbine is stuck open.

8. The method of claim 6 wherein when the estimated compressor inlet pressure has abrupt changes within a specified time and is less than the ambient pressure, the fault detection isolation indicates that the variable geometry turbine is stuck closed.

9. The method of claim 6 wherein when the estimated compressor inlet pressure is less than the ambient pressure, the fault detection isolation indicates that there is a fault in a sensor measuring the boost pressure.

10. A method of estimating a compressor inlet pressure for a turbocharger, the method comprising:
measuring an ambient temperature of air flowing into the compressor;
measuring a flow rate of the air into the compressor;
measuring a boost pressure of the air from the compressor to an engine;
determining a speed of a turbine of the turbocharger;
defining a pressure ratio as the ratio of the boost pressure to the compressor inlet pressure;
defining a function as the function of the compressor flow rate, the ambient temperature, the compressor inlet pressure and the turbine speed; and
equating the pressure ratio and the function and recursively solving for the compressor inlet pressure, wherein recursively solving is based on a linear parameter varying (LPV) dynamic model that employs a Kalman filter, the estimated compressor inlet pressure being an output of the Kalman filter.

11. The method of claim 10 further comprising measuring an exhaust flow rate of exhaust gas from the engine, measuring an exhaust temperature of the exhaust gas, measuring the wastegate position that controls a flow rate of the exhaust gas that bypasses the turbine, and determining the turbine speed as a function of the exhaust flow rate, the exhaust temperature, the compressor inlet pressure, and the wastegate position.

12. The method of claim 10 further comprising measuring an ambient pressure with a sensor, and determining a residual as the difference between the estimated compressor inlet pressure and the ambient pressure, the residual providing fault detection isolation.

13. The method of claim 12 wherein the turbine is a variable geometry turbine.

14. The method of claim 13 wherein when the estimated compressor inlet pressure has abrupt changes within a specified time and is greater than the ambient pressure, the fault detection isolation indicates that the variable geometry turbine is stuck open.

15. The method of claim 13 wherein when the estimated compressor inlet pressure has abrupt changes within a specified time and is less than the ambient pressure, the fault detection isolation indicates that the variable geometry turbine is stuck closed.

16. The method of claim 13 wherein when the estimated compressor inlet pressure is less than the ambient pressure, the fault detection isolation indicates that there is a fault in a sensor measuring the boost pressure.

17. A method of estimating a compressor inlet pressure for a turbocharger, the method comprising:
measuring an ambient temperature of air flowing into the compressor;
measuring a flow rate of the air into the compressor;
measuring a boost pressure of the air from the compressor to an engine;
measuring an exhaust flow rate of exhaust gas from the engine to a turbine;
measuring an exhaust temperature of the exhaust gas;
measuring the wastegate position that controls a flow rate of the exhaust gas that bypasses the turbine;
determining a speed of the turbine as a function the exhaust flow rate, the exhaust temperature, the compressor inlet pressure, and the wastegate position;
defining a pressure ratio as the ratio of the boost pressure to the compressor inlet pressure;
defining a function as the function of the compressor flow rate, the ambient temperature, the compressor inlet pressure and the turbine speed; and
equating the pressure ratio and the function and recursively solving for the compressor inlet pressure.

18. The method of claim 17 wherein recursively solving is based on a linear parameter varying (LPV) dynamic model.

19. The method of claim 18 wherein the LPV dynamic model employs a Kalman filter, the estimated compressor inlet pressure being an output of the Kalman filter.

20. The method of claim 17 further comprising measuring an ambient pressure with a sensor, and determining a residual as the difference between the estimated compressor inlet pressure and the ambient pressure, the residual providing fault detection isolation.
